(19) United States
(12) Patent Application Publication
(10) Pub. No.: US 2010/0018380 A1
(43) Pub. Date: Jan. 28, 2010

(54) Acoustically Pleasing Headjoint Stopper for a Transverse Flute

(76) Inventor: Mark Seidman, Philadelphia, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/178,320

(22) Filed: Jul. 23, 2008

(51) Int. Cl. G10D 7/02

(52) U.S. Cl. 84/384

(57) ABSTRACT

A headjoint stopper is arranged for mounting within the headjoint of a transverse flute of the type that includes an embouchure hole, a crown fitting, and an inside wall having a circumference. The headjoint stopper includes a front shoulder which is located closer to the embouchure-hole and a back shoulder located closer to the crown fitting. The front and back shoulders each contact the entire circumference of the inside wall to provide a seal between the headjoint and the headjoint stopper at the front and back shoulders. A midsection is located between the said front and back shoulders. The midsection does not contact the inside circumference of the headjoint to create a resonance chamber between the headjoint stopper and the inside wall of the headjoint to improve the sonic qualities of the instrument while preserving the sound characteristics of the existing headjoint.

### FIELD OF THE INVENTION

The present invention relates to an acoustically pleasing head joint stopper for a transverse flute.

### BACKGROUND OF INVENTION

This invention relates in general to headjoints for musical instruments of the flute family and in particular to headjoint stoppers. Modern flutes, including concert flutes and piccolos, are often constructed of metal and include a body portion which is detachably connected to a headjoint. The body portion includes the fingerholes and keys and the headjoint includes the embouchure hole and lip plate. Received in the free end of the headjoint is a stopper, usually made of cork, which is anchored to a crown fitting by threaded engagement. Although the body portion of the headjoint is generally cylindrical, the headjoint is typically a drawn or extruded member having a slightly tapering inside diameter. In the trade, the headjoint inside diameter is often referred to as being conical. The end of the headjoint which attaches to the body portion includes a slightly larger inside diameter than the opposite free end. The cork stopper can be inserted through either end of the headjoint.

For preferred flute response, resonance and brilliance of tone quality, the geometry of the stopper, its position with respect to the embouchure hole and its ability to seal around the inside diameter of the headjoint are all important factors. Cork, when used as a stopper, has the advantages of being lightweight, easily shaped, moderately compressible and low cost. However, cork has its disadvantages. For example, a certain amount of dampening in the headjoint is necessary, however, cork by its very nature, provides too great a degree of dampening which adversely affects the sound quality of the instrument. Cork also has the disadvantage of deteriorating with exposure to moisture and actually decreases in size over time. Consequently, the cork stopper will begin to develop air leaks which gradually become worse. A flautist may be unaware of such leaks since the deterioration is gradual. A further problem which may accelerate the development of air leaks is the quality of cork which may be obtained for the fabrication of such headjoint stoppers. If the cork is porous, then the deterioration will be more rapid. This results in a deterioration of the sonic quality of the flute, which is undesirable.

### SUMMARY OF THE INVENTION

A headjoint stopper is arranged for mounting within the headjoint of a transverse flute of the type that includes an embouchure hole, a crown fitting, and an inside wall having a circumference. The headjoint stopper includes a front shoulder which is located closer to the embouchure-hole and a back shoulder located closer to the crown fitting. The front and back shoulders are generally disc-shaped and each contacts the entire circumference of the inside wall to provide a seal between the headjoint and the headjoint stopper at the front and back shoulders of the stopper. A midsection is located between the front and back shoulders. The midsection does not contact the inside circumference of the headjoint to create a resonance chamber between the headjoint stopper and the inside wall of the headjoint to improve the sonic qualities of the instrument while preserving the sound characteristics of the existing headjoint.

### BRIEF DESCRIPTION OF THE DRAWINGS

FIG. 1 is an isometric view of a headjoint stopper of the present invention;

FIG. 2 is an elevational view, partially in section, illustrating the headjoint stopper of the present invention situated within the headjoint of a transverse flute;

FIG. 3 is an enlarged sectional view taken along line 3-3 of FIG. 2;

FIG. 4 is an enlarged elevational view of an alternative embodiment of the headjoint stopper of the present invention;

FIG. 5 is a sectional view taken along line 5-5 of FIG. 4;

FIG. 6 is an enlarged elevational view of a second alternative embodiment of the headjoint stopper of the present invention;

FIG. 7 is a sectional view taken along line 7-7 of FIG. 6;

FIG. 8 is an enlarged elevational view of a third alternative embodiment of the headjoint stopper of the present invention;

FIG. 9 is a sectional view taken along line 9-9 of FIG. 8; and,

FIG. 10 is an enlarged elevational view of several additional alternative embodiments of the headjoint stopper of the present invention.

### DETAILED DESCRIPTION OF THE INVENTION

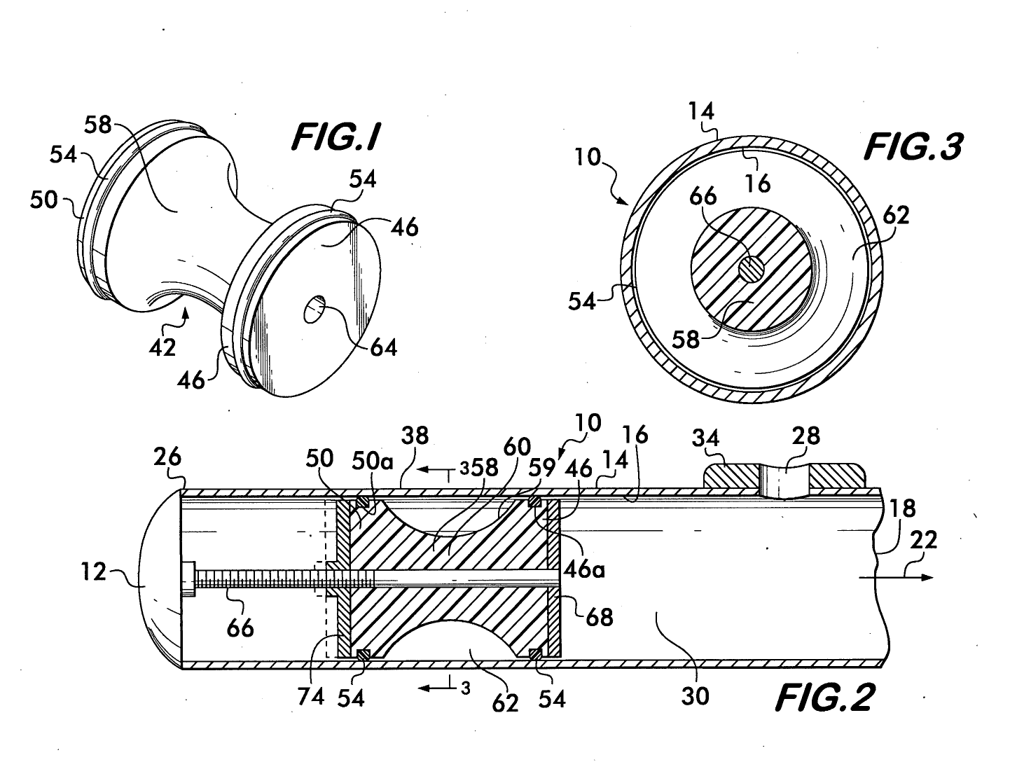

Referring now in detail to the various figures of the drawings wherein like reference characters refer to like parts, there is shown in FIG. 2, a conventional headjoint 10 for a transverse flute. Although the term “flute” is used herein, it is to be understood that this term refers generally to musical instruments of the flute family. Such instruments include concert flutes and piccolos, but may also include other instruments such as the fife or penny whistle. The headjoint 10 is that portion which attaches to the body portion of the flute. The headjoint 10 may be formed of any suitable material, e.g., wood, metal, silver, gold, bamboo, etc., and includes a cylindrical wall 14 having an inside surface 16. The cylindrical wall 14 is adapted to interconnect at its forward end 18 to the body of a musical instrument, e.g., a flute body (indicated in the direction of the arrow 22, but not shown).

At the rearmost end 26 of the cylindrical wall 14, a button or crown 12 engages the cylindrical wall 14. A hole 28 extends through the cylindrical wall 14 in proximity to the forward end 18. The hole 28 is known as the embouchure and communicates with an acoustic chamber 30 defined within the cylindrical wall 14. The embouchure 28 is located in a lip plate 34, and the player blows across the embouchure 28 to produce sound. Inclusion of the lip plate 34 is common but not necessary depending upon the type of flute. A closure end 38 of the cylindrical wall 14 is that portion between the embouchure 28 and the cylindrical wall's rearmost end 26.

Under the prior art, to function correctly, the closure end 38 of the cylindrical wall 14 is sealed to make it air tight by using a cork stopper (not shown) located inside the cylindrical wall 14 a short distance behind the embouchure 28. The cork (not shown) is a tight fit because at that point the cylindrical wall 14 is customarily tapered, narrowing in the opposite direction to the instrument's body. The cork stopper has been used in flute headjoints for over one-hundred years. They were first used at a time when headjoints were usually made of wood, had irregular bores, and the instrument's pitch and tuning were imperfect which the adjustable cork was intended to correct. Modern transverse flutes, i.e., Boehm system transverse flutes, are made of other material, generally metal, and their tuning has been corrected by changing the tone-holes.

A transverse flute makes notes because a column of air, supported inside the instrument, is excited by a smaller column of air passing across the embouchure 28. A certain amount of dampening in the headjoint 10 is necessary, however, the cork (not shown) by its very nature, provides too great a degree of dampening which adversely affects the sound or sonority of the instrument. As flautists well know, when the instrument is responding well, vibrations can be felt throughout. Equally, the head joint is where the vibrations originate and where the sound is generated. This is demonstrated by watching any flautist playing beside a microphone. The flute is played with the embouchure closest to the microphone to get the best results. Essentially, the cork dampens the vibrations at the point where the flute is most sensitive, holding a potentially vibrant piece of metal, the cylindrical wall of the headjoint, and inhibiting it from resonating. The cork dampens the resonating sound much more than is necessary, stifling the resonance and diminishing the amplification of the instrument. While too much dampening within the headjoint 10 will stifle sound reflection and sound resonance and diminish the amplification of the instrument, conversely, too little dampening within the headjoint 10 will result in a sound considered to be too bright and brassy.

In the various embodiments of the invention, the customary stopper of cork is replaced by one of the embodiments of a headjoint stopper best shown in FIGS. 1 through 10. Referring now to FIGS. 1 through 3, there is shown a first embodiment 42 of the headjoint stopper of the present invention. The headjoint stopper 42 is formed generally in the shape of an hourglass and includes a generally disc-shaped front shoulder 46 located closer to the embouchure 26 and a generally disc-shaped back shoulder 50, located closer to the rearmost end 26 of the cylindrical wall 14. The front and back shoulders 46, 50 of the headjoint stopper 42 each have a generally circular external configuration that is sized to provide an interference fit or a press fit within the inside surface 16 of the cylindrical wall 14 of the headjoint 10 so as to make contact with the inside surface 16 of the cylindrical wall 14 around its entire circumference to provide a seal between the headjoint 10 and the headjoint stopper 42 at the front and back shoulders thereof. The outer dimensions, e.g., length and outer diameter, of the headjoint stopper 42 may be approximately equal to that of the prior art cork headjoint stopper to enable the headjoint stopper 42 to fit into the same space within the existing designs of headjoints 10 of major manufacturers without the need for modifications to the headjoint 10, its related parts, or other parts of the instrument.

Alternatively, as best shown in FIG. 2, the front and back shoulders, 46 and 50, may be sized slightly smaller than the inside diameter of the headpiece 10 and provided with circumferenctial grooves, indicated at 46a and 50a. An O-ring 54 is made of any material that is suitably soft and is utilized to hold the headjoint stopper 42 in place within the headjoint 10 and provide a suitable level of sound dampening. For example, an O-ring 54 formed of a suitable nitrile rubber may be sized to seat snugly within the grooves 46a and 50a and provide an interference fit or press fit with the inside surface 16 of the cylindrical wall 14 to create an effective seal between the front and back shoulders of the headjoint stopper 42 and the inner surface 16 of the cylindrical wall 14. The headjoint stopper 42 is made of any suitable sound reflective material such as a resinous synthetic plastic material sold under the Registered Trademark DELRIN of E.I. DuPont de Nemours Company. Other suitable sound reflective materials for the headjoint stopper 42 include gold, silver and wood.

To complete the hourglass shape, a midsection 58 of the headjoint stopper 42 is provided. Preferably, the the headjoint stopper 42 is formed (e.g., molded) as a one-piece or unitary member comprising the midsection 58, and front and back shoulders 46, 50. The midsection narrows from the front and back shoulders 46, 50 towards a narrowest point 60 at approximately the center of the headjoint stopper 42. In particular, as best shown in FIG. 2, the hourglass shape is formed as the midsection 58 narrows along an arc of a circle indicated at 59 from the front and back shoulders 46, 50 towards the narrowest point 60 located midway between the front and back shoulders 46, 50 of the headjoint stopper 42. Preferably, the radius of curvature of the arc 59 is approximately equal to the radius of curvature of the cylindrical wall 14. However, it should be understood that a midsection formed of an arc having a different radius of curvature or shape, e.g., parabolic, could be employed without departing from the scope of this invention.

No portion of the midsection 58 contacts the inside surface 16 of the cylindrical wall 14, thus creating a volume or void 62. The void 62 is defined as that volume between the front and back shoulders 46, 52 of the headjoint stopper 42, and between the inside surface 16 and the midsection 58. This void is shaped and sized to create a resonance chamber 62 which noticeably improves the tone, pitch, timbre, resonance, clarity and overall sound of the instrument, while preserving the sound characteristics of the existing headjoint 10.

As the headjoint stopper 42 contacts the inner surface 16 only at the front and back shoulders, 46 and 50, the degree of dampening that occurs in the headjoint 10 is considerably reduced when compared with the degree of dampening resulting from use of the prior art cork stopper which contacts the inner surface along the cork stopper's entire length. Preferably, the thickness of the midsection 58 at its narrowest point 60 is one half the diameter of the inside surface 16 of the cylinder wall 14. Moreover, the materials specified above for the headjoint stopper 62 are harder than the prior art stopper formed of cork, which also contributes to reducing excessive dampening and increasing sound reflection and sound resonance.

Usually, an instrument such as a flute is provided with components for mounting and retaining the headjoint stopper within the headjoint 10. In particular, the mounting components include a spindle 66 (FIGS. 2 and 3) which attaches at one end to a disc-shaped mounting plate 68. The mounting plate 68 engages the front shoulder 46 of the headjoint stopper 42. To effectuate such mounting, the headjoint stopper 42 is provided with a central opening 64 (FIG. 1) therethrough. The central opening 64 of the headjoint stopper 42 is sized to permit non-interfering passage of the spindle 66 therethrough. At its opposite end, the spindle 66 is mounted to a button or crown 12, also a mounting component. The crown 12 engages the rearmost end 26 of the cylindrical wall 14. A portion of the spindle 66 is screw threaded for threaded engagement with a disc-shaped mounting plate 74, which engages the back shoulder 50 of the headjoint stopper 42.

Typically, the mounting plates 68, 74 are made of the same materials as the flute body (not shown) and headpiece 10, e.g., sterling silver, gold, nickel, brass, etc. Thus, by turning the crown 12 either clockwise or counterclockwise, the mounting plates 68 and 74, both of which make a clearance fit relative to the cylindrical wall 16, move axially to urge the headjoint stopper 42 tightly home within the tapered cylindrical bore 14. By adjusting the position of the headjoint stopper 42 by turning the crown 12, the flute may be appropriately tuned to a desired frequency, e.g., 440 or 442 cycles per second.

Alternatively, to improve the sonic characteristics of the instrument, or for other reasons, a player may choose to eliminate the mounting plates 68 and 74 entirely. Under these circumstances, the central opening 64 of the headjoint stopper 42 may be sized slightly smaller than the circumference of the spindle 66 to provide an interfering fit with the spindle 66 disposed therein such that the headjoint stopper 42 may be retained on the spindle 66 and within the headjoint 10 without the need for the mounting plates 68 and 74. Alternatively, screws (not shown) may be substituted for mounting plates 68 and 74 to secure and retain the headjoint stopper 42 on the spindle 66.

Alternatively, as is often the case with instruments such as a penny whistle or a fife, the instrument may be provided without any of the mounting components described above, e.g., the spindle, mounting plates, and crown. For such instruments, the headpiece stopper 42 may be provided without a central opening 64 and may be sized to securely fit within the headpiece of such instruments without the need for any mounting hardware.

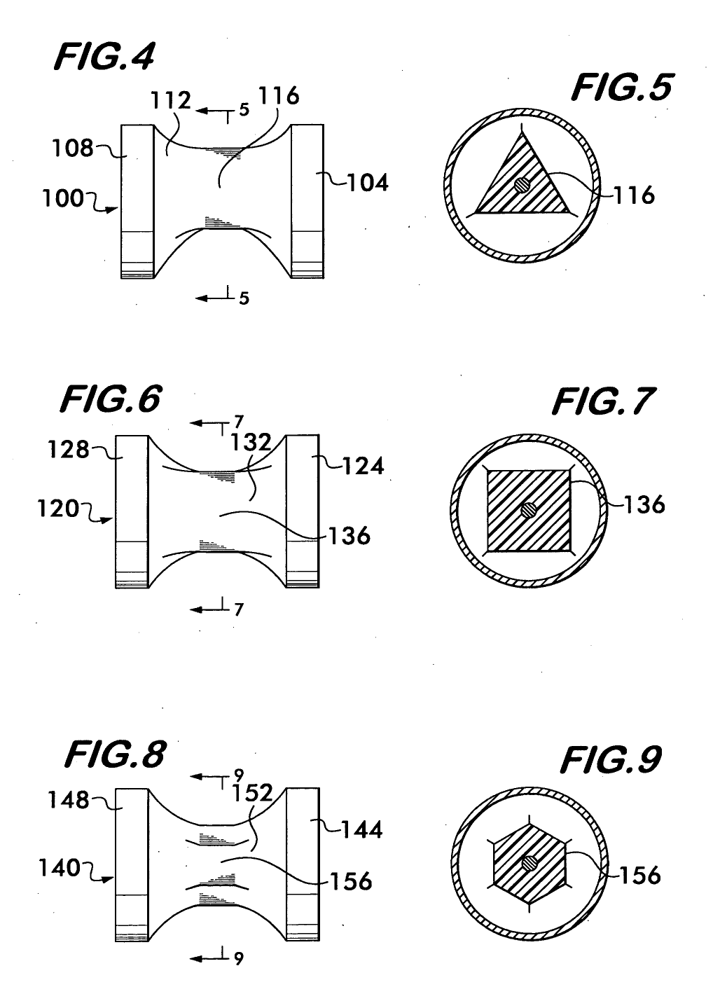

The present invention is not limited by the hourglass shaped midsection 58 described in connection with the first embodiment 42 and other midsection shapes are contemplated utilizing the materials discussed above without departing from the scope of the invention. Referring now to FIGS. 4 and 5, there is shown at 100 an alternative embodiment headjoint stopper of the present invention. This embodiment 100 includes front and back shoulders 104, 108 and a midsection 112 which narrows from the front and back shoulders 104, 108 towards the center 116 of the midsection 112 where the midsection 112 is narrowest. As best shown in FIGS. 4 and 5, at the center 116, the cross-section of the midsection is triangular in shape.

Referring now to FIGS. 6 and 7, there is shown at 120 a second alternative embodiment headjoint stopper of the present invention. This embodiment 120 includes front and back shoulders 124, 128 and a midsection 132 which narrows from the front and back shoulders 124, 128 towards a center 136 of the midsection 132 where the midsection 132 is narrowest. As best shown in FIGS. 6 and 7, at the center 136, the cross-section of the midsection 132 is square in shape. Likewise, as best shown in FIGS. 8 and 9, there is shown at 140, a third alternative embodiment headjoint stopper which includes front and back shoulders 144, 148 and a midsection 152 which narrows from the front and back shoulders 144, 148 towards the center 156 of the midsection 152 where the midsection 152 is narrowest. At the center 156, the cross-section of the midsection 152 is hexagonal in shape.

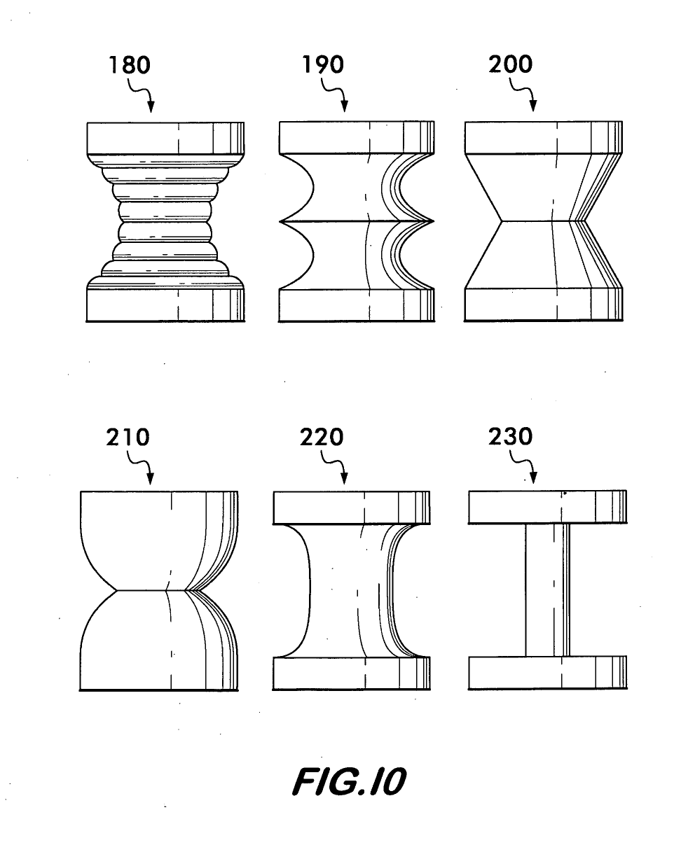

Referring now to FIG. 10, there are shown several additional alternative embodiments 180, 190, 200, 210, 220, and 230, of the headjoint stopper of the present invention. Each embodiment shown in FIG. 10 includes a different midsection profile to create a different resonance chamber within the headpiece resulting in different sonic qualities and characteristics of the instrument which different users may find appealing. While the invention has been described in detail and with reference to specific examples thereof, it will be apparent to one skilled in the art that various changes and modifications can be made therein without departing from the spirit and scope thereof.

What is claimed:

1. A headjoint stopper for mounting within the headjoint of a transverse flute, the headjoint including an embouchure hole, a crown fitting, and an inside wall having a circumference, said headjoint stopper comprising:
a. a front shoulder located closer to said embouchure-hole and a back shoulder located closer to said crown fitting, said front and back shoulders making contact with the entire circumference of the inside wall to provide a seal between said headjoint and said headjoint stopper at said front and back shoulders; and,
b. a midsection located between said front and back shoulders, said midsection not contacting the inside circumference of said headjoint to create a resonance chamber between said headjoint stopper and the inside wall of the headjoint.

2. The headjoint stopper of claim 1, wherein said front shoulder is sized slightly smaller than the inside wall and wherein said front shoulder additionally comprises a groove encircling the circumference thereof, and wherein said headjoint stopper additionally comprises a deformable sealing member arranged to be disposed within said groove and sized to make contact with the entire circumference of the inside wall of the headjoint.

3. The headjoint stopper of claim 2, wherein said back shoulder is sized slightly smaller than the inside wall and wherein said rear shoulder additionally comprises a groove encircling the circumference thereof, and wherein said headjoint stopper additionally comprises a deformable sealing member arranged to be disposed within said groove and sized to make contact with the entire circumference of the inside wall of the headjoint.

4. The headjoint stopper of claim 3, wherein said sealing member is formed of a sound dampening material.

5. The headjoint stopper of claim 4, wherein said sealing member is an o-ring formed of a nitrile rubber.

6. The headjoint stopper of claim 1, wherein said headjoint stopper is formed of a sound reflective material.

7. The headjoint stopper of claim 1, wherein the headjoint additionally comprises mounting hardware including a first mounting plate engaging said front shoulder of said headjoint stopper and a second mounting plate engaging said back shoulder of said headjoint stopper, each said mounting plate including a center hole extending therethrough, and said headjoint stopper additionally comprising a central opening passing through the length thereof, said crown fitting including a rod axially extending therefrom and passing through the center holes of the first and second mounting plates and through the central opening said headjoint stopper.

8. The headjoint stopper of claim 7, wherein said rod is integral with said crown fitting.

9. The headjoint stopper of claim 7, wherein said center hole of said headjoint stopper includes a diameter which is slightly smaller than the diameter of said externally threaded rod.

10. The headjoint stopper of claim 1, wherein said midsection has an overall shape of an hourglass.

11. The headjoint stopper of claim 1, wherein said midsection narrows from said front and back shoulders towards a narrowest point.

12. The headjoint stopper of claim 11, wherein said narrowest point is located approximately midway between said shoulders.

13. The headjoint stopper of claim 12, wherein said midsection narrows along an arc of a circle from said front and back shoulders towards said narrowest point.

14. The headjoint stopper of claim 13, wherein said arc includes a radius of curvature that is approximately equal to the radius of curvature of the headjoint inside wall.

15. The headjoint stopper of claim 11, wherein said narrowest point comprises a thickness that is approximately one half the diameter of the inside wall of the headjoint.

16. The headjoint stopper of claim 11, wherein said narrowest point includes a triangular cross-sectional shape.

17. The headjoint stopper of claim 11, wherein said narrowest point includes a square cross-sectional shape.

18. The headjoint stopper of claim 11, wherein said narrowest point includes a hexagonal cross-sectional shape.

19. The headjoint stopper of claim 11, wherein said narrowest point includes a polygonal cross-sectional shape.

20. The headjoint stopper of claim 11, wherein said narrowest point includes a circular cross-sectional shape.

21. The headjoint stopper of claim 1, wherein said headjoint stopper is formed as a unitary construction comprising said front and back shoulders and said midsection.

22. The headjoint stopper of claim 21, wherein said headjoint stopper is formed by molding.

23. The headjoint stopper of claim 1, wherein said headjoint stopper includes a central opening passing therethrough, and wherein the headjoint includes mounting hardware comprising a spindle, said central opening being sized to permit non-interfering passage of the spindle therethrough.

24. The headjoint stopper of claim 1, wherein said headjoint stopper includes a central opening passing therethrough, and wherein the headjoint includes mounting hardware comprising a spindle, said central opening being sized to providing an interfering fit with the spindle disposed therein.

25. The headjoint stopper of claim 1, wherein said headjoint stopper does not include a central opening.
